(19) United States
(12) Patent Application Publication
(10) Pub. No.: US 2005/0008882 A1
(43) Pub. Date: Jan. 13, 2005

(54) Phenol resin composition and phenol resin copper-clad laminate

(76) Inventors: Miki Satou, Oyama-shi (JP); Yoshiyuki Narabu, Shimodate-shi (JP); Kazunaga Sakai, Oyama-shi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/886,630

(22) Filed: Jul. 9, 2004

(30) Foreign Application Priority Data
Jul. 11, 2003 (JP) 2003-195660

(51) Int. Cl. B32B 27/42; B32B 15/08; C08G 2/00

(52) U.S. Cl. 428/460; 524/127

(57) ABSTRACT

The present invention provides a phenol resin composition which does not cause any defect such as blister in a reflow step and which are excellent in flame resistance and stamping properties, and a phenol resin copper-clad laminate in which the above composition is used. The invention relates to a phenol resin composition which is obtainable by blending a melamine-modified phenol novolak resin with a phosphate ester, an epoxy resin and a dry oil-modified phenol resin, and also relates to a phenol resin copper-clad laminate which is obtainable by impregnating paper-based sheets with the above phenol resin composition, drying them to obtain prepregs, superimposing the prepregs on each other, and then a laminating copper foil on the outermost layer of the prepregs.

### BACKGROUND OF THE INVENTION

1. Technical Field

The present invention relates to a phenol resin composition and a phenol resin copper-clad laminate using the same.

2. Description of the Related Art

With recent miniaturization and multifunctionalization of electronic devices, printed wiring boards are also being densified and miniaturized. In such electronic devices, paper-based phenol resin copper-clad laminates are widely used as substrates for printed wiring boards of household electronic devices, because the laminates are excellent in stamping properties as well as drilling properties and they are also inexpensive.

The paper-based phenol resin laminate is produced by reacting a phenol and an aldehyde in the presence of an alkali catalyst to obtain a phenol resol resin, dissolving the resin in a solvent, impregnating paper-based sheets with the resultant solution, drying them to obtain prepregs, superimposing the several prepregs on each other, and then heating and pressing them. Usually, the prepregs are combined with a copper foil to form a copper-clad laminate, and the copper foil is then etched to form a circuit, thereby preparing a printed wiring board.

Moreover, owing to environmental protection, set makers have investigated or employed materials using no halogen flame retardant (halogen-free materials) and lead-free solder using no lead which is a harmful substance. For example, these materials are disclosed in Japanese Patent Laid-open No. 2001-181474. However, the lead-free solder has a higher melting temperature as compared with a conventional lead-containing solder (Sn—Pb). Therefore, a set temperature in a reflow step tends to be high. Thus, in recent years, there is required the improvement of heat resistance of the printed wiring boards, particularly the improvement of heat resistance in the reflow step.

The paper-based phenol resin copper-clad laminates are inexpensive, and therefore they are widely used. However, their heat-resistant levels are lower as compared with glass-based epoxy resin copper-clad laminates, and hence the temperature in the reflow step is also set at a low level. In consequence, when the set temperature is high, defects such as blister may occur. On the other hand, since the melting temperature of the lead-free solder is higher than that of the conventional solder (Sn—Pb), the temperature in the reflow step is set at a high temperature. Therefore, the printed wiring boards using the paper-based phenol resin copper-clad laminates containing lead-free solder tend to have defects such as blister.

As the phenol resin used in the paper-based phenol resin copper-clad laminate, a dry oil-modified phenol resol resin is mainly used in order to impart good stamping properties. However, the phenol resol resin forms water at a curing reaction during lamination and the water remains in the laminate. It is the main reason for decreased heat resistance. Moreover, when the dry oil is used, the ratio of combustible materials in the resin increases. In particular, in the case that the phenol resin is halogen-free, a sufficient flame resistance cannot be obtained unless a large amount of a phosphorus or nitrogen flame retardant is blended as described in Japanese Patent Laid-open No. 2001-181474. However, when a phosphorus flame retardant is used in a certain amount or more, the number of fine cracks at the time of stamping increases and water absorbability and heat resistance decrease. Furthermore, when a melamine-modified phenol resin is used in a certain amount or more as a nitrogen flame retardant, it is known that exfoliation increases at low-temperature stamping.

Hitherto, there is required a phenol resin composition having good flame resistance and stamping properties with no occurrence of defects such as blister in a reflow step when lead-free solder is used for printed wiring board, and also a phenol resin copper-clad laminate (halogen-free paper-based phenol resin copper-clad laminate) using the same.

### SUMMARY OF THE INVENTION

Embodiments of the present invention are as follows:

(1) A phenol resin composition comprising: a melamine-modified phenol novolak resin; a phosphate ester; an epoxy resin; and a dry oil-modified phenol resin. (2) The phenol resin composition described in (1), which comprises 80 to 150 parts by weight of the phosphate ester 5 to 30 parts by weight of the epoxy resin and 65 to 100 parts by weight of the dry oil-modified phenol resin with respect to 100 parts by weight of the melamine-modified phenol novolak resin.

(3) A phenol resin copper-clad laminate which is obtainable by impregnating paper-based sheets with the phenol resin composition described in (1) or (2), drying them to prepare prepregs, superimposing the prepregs on each other, and then laminating a copper foil on the outermost layer of the prepregs.

According to the embodiments of the present invention, there are provided a halogen-free phenol resin composition which does not bring about defects such as blister in a reflow step when a lead-free solder is used for printed wiring boards, and which is excellent in stamping properties, and also a paper-based phenol resin copper-clad laminate in which the above composition is used.

The present disclosure relates to subject matter contained in Japanese Patent Application No.2003-195660, filed on Jul. 11, 2003, the disclosure of which is expressly incorporated herein by reference in its entirety.

### DETAILED DESCRIPTION OF THE INVENTION

A melamine-modified phenol novolak resin for use in the present invention preferably contains 3 to 15% by weight of nitrogen. When nitrogen is less than 3% by weight, a sufficient flame resistance cannot be obtained in some cases, and when it exceeds 15% by weight, heat resistance and stamping properties are poor in some cases. An example of the melamine-modified phenol novolak resin includes, but not limited to, a melamine-modified phenol novolak resin (trade name: PR-6000 manufactured by Hitachi Chemical Co., Ltd.).

Examples of a phosphate ester for use in the present invention includes, but are not limited to, triethyl phosphate, tributyl phosphate, triphenyl phosphate, tricresyl phosphate, cresyl diphenyl phosphate, resorcyl diphenyl phosphate, and triisopropyl phenyl phosphate. They may be used singly or in combination of two or more of them. In particular, triphenyl phosphate is preferable because of being inexpensive.

The phosphate ester is preferably blended in an amount of 80 to 150 parts by weight with respect to 100 parts by weight of the melamine-modified phenol novolak resin. The phosphate ester functions as a flame retardant and a plasticizer. Therefore, when the amount of the blended phosphate ester is insuffcient, the laminate is poor in flame resistance and tends to occur exfoliation at the time of stamping. On the contrary, when it exceeds 150 parts by weight, white-eye (Mejiro; fine cracks on the resin around the hole) is remarkable at the time of the stamping, and water absorbability and heat resistance decrease in some cases.

An epoxy resin for use in the present invention preferably has an epoxy equivalent of 100 to 1000 and a weight-average molecular weight of 5000 or less and has two or more epoxy groups in a molecule. Examples of the epoxy resin include, but are not limited to, bisphenol A epoxy resins, bisphenol F epoxy resins, bisphenol S epoxy resins, alicyclic epoxy resins, phenol novolak epoxy resins, cresol novolak epoxy resins, bisphenol A novolak epoxy resins, diglycidyl-etherified products of polyfunctional phenols, and diglycidyl-etherified products of polyfunctional alcohols. They may be used singly or in combination of two or more. Among them, a liquid epoxy resin having an epoxy equivalent of 150 to 230 is preferable because of good workability.

The epoxy resin is preferably blended in an amount of 5 to 30 parts by weight with respect to 100 parts by weight of the melamine-modified phenol novolak resin. The epoxy resin is easily reacted with the melamine-modified phenol novolak resin to form a tough resin. However, when more than 30% parts by weight of the epoxy resin is blended, the reaction proceeds in a stage of a varnish or prepregs to shorten a pot life in some cases. On the contrary, when the amount of the epoxy resin is less than 5 parts by weight, the toughness of the resin becomes insufficient, and heat resistance and stamping properties deteriorate in some cases.

A dry oil-modified phenol resin for use in the present invention is preferably a dry oil-modified phenol resol resin. The dry oil-modified phenol resol resin is obtained by reacting a phenol with a dry oil in the presence of an acid catalyst, followed by the reaction with an aldehyde in the presence of an alkali catalyst.

Examples of the usable dry oil include, but are not limited to, tung oil, linseed oil, dehydrated castor oil, and oiticica oil. Examples of the usable phenol include, but not llimited to, phenol, m-cresol, p-cresol, o-cresol, isopropylphenol, and nonylphenol. A modification rate of the dry oil is preferably from 10 to 40% by weight. When the modification rate is less than 10% by weight, stamping properties are poor in some cases. On the contrary, when it exceeds 40% by weight, flame resistance deteriorates in some cases.

Examples of the usable aldehyde include, but are not particularly limited to, formaldehyde, paraformaldehyde, acetaldehyde, paraacetaldehyde, butylaldehyde, octylaldehyde, and benzaldehyde. Among them, formaldehyde and paraformaldehyde are preferable. An example of the acid catalyst is p-toluenesulfonic acid, and examples of the alkali catalyst include amine catalysts such as ammonia, trimethylamine, and triethylamine.

The dry oil-modified phenol resol resin is preferably blended in an amount of 65 to 100 parts by weight with respect to 100 parts by weight of the melamine-modified phenol novolak resin. The dry oil-modified phenol resol resin is preferably dispersed homogeneously in the phenol resin composition to impart plasticity. When the blended amount is less than 65 parts by weight, stamping properties decrease in some cases. Moreover, when the resin is blended in an amount exceeding 100 parts by weight, heat resistance decreases in some cases owing to the oil component contained.

The phenol resin composition of the present invention is dissolved or dispersed in a solvent to regulate the composition, and the thus regulated composition is then used as a varnish to impregnate paper-based sheets therewith. An example of the solvent is methanol. The varnish may be blended with a flame retardant other than the phosphate ester, for example, an inorganic filler-based flame retardant such as aluminum hydroxide, boric acid, zinc borate or magnesium hydroxide in such a manner that the amount of the flame retardant may be not more than 30 parts by weight of 100 parts by weight of the total composition. When the flame retardant other than the phosphate ester is blended, flame resistance can be enhanced by synergistic action and hence the case is preferable. When the blended amount of these flame retardants other than the phosphate ester exceeds 30 parts by weight, stamping properties and heat resistance tend to deteriorate.

Form the viewpoint of stamping properties, the base material to be used is preferably paper-based sheets. As the paper-based sheets, there can be used kraft papers, cotton linter papers, mixed papers of linter and kraft pulp, mixed papers of glass fibers and paper fibers, and the like.

It is preferable that the paper-based sheets are beforehand impregnated with a water-soluble phenol resin and then dried prior to the use of them.

Furthermore, the resulting paper-based sheets are impregnated with the varnish containing the above phenol resin composition and then dried to form prepregs. At this time, it is preferable to use a water-soluble phenol resin mixed with a solution containing an alkoxysilane derivative or its condensate, whereby heat resistance is further improved. The predetermined number of the thus obtained prepregs are superimposed on each other, and a copper foil is then laminated on the outermost layer of the prepregs, followed by heating and pressing to prepare a paper-based phenol resin copper-clad laminate. Lamination conditions are preferably a temperature of 150 to 180° C., a pressure of 9 to 20 MPa, and a period of 30 to 120 minutes.

The following will specifically describe the present invention with reference to examples, but the invention is not limited thereto.

(Synthesis of Dry Oil-Modified Phenol Resol Resin)

Into a reaction vessel were placed 150 parts by weight of tung oil, 280 parts by weight of phenol, and 0.2 part by weight of p-toluenesulfonic acid, followed by 1 hour of a reaction. Then, 200 parts by weight of paraformaldehyde and 30 parts by weight of 28% by weight ammonia water were added thereto and the mixture was reacted at 75° C. for 2 hours to obtain a tung oil-modified phenol resol resin having a tung oil-modification rate of 35% by weight.

(Blending and Preparation of Phenol Resin for Overcoat)

With 100 parts by weight of a melamine-modified phenol novolak resin (trade name: PR-6000 manufactured by Hitachi Chemical Co., Ltd.) were blended triphenylphosphate, the tung oil-modified phenol resol resin, and an epoxy resin (EPICLON 840-S manufactured by Dainippon Ink & Chemicals, Incorporated) in amounts shown in Table 1, and the whole was dissolved in methanol to prepare a phenol resin composition varnish having a solid content of 50% by weight.

(Synthesis of Water-Soluble Phenol Resin for Undercoat)

One molar amount of phenol, 1.2 molar amount, in terms of formaldehyde, of 37% by weight formalin, and 0.4 molar amount, in terms of triethylamine, of a triethylamine aqueous solution (concentration: 30% by weight) were reacted at 70° C. for 6 hours to obtain a water-soluble phenol resin. The resulting water-soluble phenol resin is diluted with a mixed solvent of water/methanol of 1/1 by weight to obtain a water-soluble phenol resin for undercoat having a solid content of 12% by weight.

### EXAMPLES 1 AND 2

A kraft paper having a thickness of 0.2 mm and a basis weight (weight of one sheet of paper per 1 m²) of 125 g/m² was impregnated with the water-soluble phenol resin varnish for undercoat so that its attached amount after drying was 18% by weight, followed by drying. Then, the impregnated paper was further impregnated with the phenol resin varnish for overcoat so that total resin-attached amount was 50% by weight and dried to obtain a prepreg. Eight sheets of the resulting prepregs were superimposed on each other, and copper foils with an adhesive having a foil thickness of 35 μm were superimposed at the both sides so that the adhesive layers are toward the prepreg side. It was heated and pressurized at 170° C. under 15 MPa for 90 minutes to obtain a double-sided phenol resin copper-clad laminate having a thickness of 1.6 mm.

### COMPARATIVE EXAMPLES 1 TO 3

(Blending and Preparation of Phenol Resin for Overcoat)

With a melamine-modified phenol novolak resin (trade name: PR-6000 manufactured by Hitachi Chemical Co., Ltd.) were blended triphenyl phosphate and the tung oil-modified phenol resol resin having a tung oil-modification rate of 35% by weight in amounts shown in Table 1, and the whole was dissolved in methanol to prepare a phenol resin varnish having a solid content of 50% by weight. Except for the above, a double-sided phenol resin copper-clad laminate having a thickness of 1.6 mm was obtained in the same manner as in Examples 1 and 2.

With regard to the double-sided phenol resin copper-clad laminate obtained in the above, reflow heat resistance, flame resistance and stamping properties were evaluated. The results are shown in Table 1. Test methods are as follows.

(Reflow Heat Resistance Test)

The copper foils of the resulting phenol resin copper-clad laminate were etched to prepare a printed wiring board having a remaining copper rate of 70%. In a reflow apparatus, the printed wiring board was flowed and presence of blister was visually observed. The temperature of the reflow apparatus was set so that maximum temperature of base material surface of the printed wiring board was 240, 250, or 260° C., and measurement was carried out. In Table 1, absence of blister was indicated by ◯, while presence of blister was indicated by X.

(Flame Resistance Test)

The copper foils of the resulting phenol resin copper-clad laminate were etched over a whole area and then a test piece of 127×13 mm was cut off. The test piece was held so that the long edge was in a perpendicular position. The test piece was brought into contact with flame from the bottom for 10 seconds by a burner and this operation was repeated twice. A period required for quenching flame was measured. The flame resistance test was carried out on five test pieces and evaluation was conducted in accordance with the UL method.

(Stamping Properties Test)

Stamping was conducted using a 24-hole test mold having a punch diameter of 1.0 to 1.2 mm, a pitch between holes of 2.54 mm while surface temperature of the test piece was changed. The periphery of holes of the punched test piece were visually observed and the state was indicated by symbols (◯: no exfoliation and no white-eye, Δ: slight exfoliation and white-eye, X: presence of exfoliation and white-eye). “White-eye” herein means a whitening phenomenon caused by occurrence of a number of fine cracks on the resin at the periphery of the hole surface when the test piece was punched.

TABLE 1

| | | Example | | Comparative Example | | |
|---|---|---|---|---|---|---|
| | | 1 | 2 | 1 | 2 | 3 |
| Melamine-modified phenol | | 100 | 100 | 100 | 100 | 150 |
| novolak resin* | | | | | | |
| Tung oil-modified phenol | | 70 | 70 | — | 70 | 100 |
| resol resin* | | | | | | |
| Triphenyl phosphate* | | 40 | 80 | 40 | 40 | 40 |
| Epoxy resin | | 15 | 15 | — | — | — |
| Reflow heat | 240° C. | ◯ | ◯ | ◯ | ◯ | ◯ |
| resistance (maximum | 250° C. | ◯ | ◯ | ◯ | ◯ | X |
| surface | 260° C. | ◯ | ◯ | X | X | X |
| temperature) | | | | | | |
| Flame resistance (UL method) | | 94 V-1 | 94 V-0 | 94 V-0 | 94 V-0 | 94 V-0 |
| Stamping properties | 40° C. | Δ | ◯ | X | X | ◯ |
| (surface | 50° C. | ◯ | ◯ | X | ◯-Δ | ◯ |
| temperature) | 60° C. | ◯ | ◯-Δ | Δ | Δ | ◯-Δ |

*parts by weight

As shown in Examples 1 and 2, in the phenol resin compositions of the present invention, good reflow heat resistance and stamping properties were observed. Moreover, as shown in Example 2, the amount of triphenyl phosphate was increased to 80 parts by weight, flame resistance became better than that in Example 1 and thus requirements of UL94V-0 were satisfied.

On the other hand, in Comparative Examples, blister, exfoliation, and white-eye occurred. Therefore, it is apparent that reflow heat resistance and stamping properties are poor.

It should be understood that the foregoing relates to only a preferred embodiment of the invention, and it is intended to cover all changes and modifications of the examples of the invention herein chosen for the purposes of the disclosure, which do not constitute departures from the sprit and scope of the invention.

1. A phenol resin composition comprising a melamine-modified phenol novolak resin, a phosphate ester, an epoxy resin, and a dry oil-modified phenol resin.

2. The phenol resin composition according to claim 1, which comprises 80 to 150 parts by weight of the phosphate ester, 5 to 30 parts by weight of the epoxy resin, and 65 to 100 parts by weight of the dry oil-modified phenol resin with respect to 100 parts by weight of the melamine-modified phenol novolak resin.

3. A phenol resin copper-clad laminate which is obtainable by impregnating paper-based sheets with the phenol resin composition according to claim 1, drying them to prepare prepregs, superimposing the prepregs on each other, and then laminating a copper foil on the outermost layer of the prepregs.

4. A phenol resin copper-clad laminate which is obtainable by impregnating paper-based sheets with the phenol resin composition according to claim 2, drying them to prepare prepregs, superimposing the prepregs on each other, and then laminating a copper foil on the outermost layer of the prepregs.
